(19) United States
(12) Patent Application Publication
(10) Pub. No.: US 2014/0339947 A1
(43) Pub. Date: Nov. 20, 2014

(54) Multi-Piece Stator For An Electric Motor

(71) Applicant: Lasko Holdings, Inc., Wilmington, DE (US)

(72) Inventors: Pei Hui Wen, Taichung (TW); Chia Hung Chang, Taichung (TW)

(73) Assignee: Lasko Holdings, Inc., Wilmington, DE (US)

(21) Appl. No.: 14/086,586

(22) Filed: Nov. 21, 2013

(30) Foreign Application Priority Data
May 16, 2013 (CN) 201320268596.4
May 16, 2013 (CN) 201320268978.7

(51) Int. Cl. H02K 1/14; H02K 15/02

(52) U.S. Cl. CPC H02K 1/14; H02K 15/022
USPC 310/194; 310/254.1; 29/596

(57) ABSTRACT

A multi-piece stator includes a pole cluster, a flux ring, and an insulation member. A rotor cavity is located at a center of the pole cluster, and multiple flux poles extend radially outward from the rotor cavity in a circumferential arrangement. The pole cluster includes a flux impedance feature between each of the multiple flux poles, and multiple bridge features maintaining the arrangement of the flux poles. The flux ring includes a ring wall having a minimum wall thickness and a pole cluster cavity defined by the ring wall. The insulation member has a shape corresponding substantially to a shape of the pole cluster and is located to effectively cover an outside surface of the flux poles. The pole cluster, the insulation member, and a field generation coil wrapped around a portion of the insulation member and a portion of the pole cluster are inserted into the pole cluster cavity.

### CROSS-REFERENCE TO RELATED APPLICATIONS

This application claims priority to Chinese Patent Application Nos. 201320268978.7 and 201320268596.4, each filed on May 16, 2013, which are incorporated herein by reference in their entirety.

### TECHNOLOGY FIELD

The present invention relates to electric motors. More specifically, the present invention relates to an improved stator structure for use with an electric motor.

### BACKGROUND

Electric motors are well known and widely used. Conventional motors may include direct current motors, permanent magnetic motors, alternating current motors, capacitor start motors, and the like. Motors of all types are utilized in various forms in multiple industrial and domestic settings.

Although the usefulness of the electric motor has been proven over many years, current designs of conventional motors have several disadvantages. As labor costs and material costs have increased, the ability to economically incorporate a conventional electric motor into low cost consumer goods has become more and more difficult. Two manufacturing components that have major impact on the overall cost of a conventional electric motor are materials and labor.

One of the materials utilized in the fabrication of a conventional motor is copper. World prices for copper have increased dramatically over time. Coupled with elevated copper prices are rising labor costs on a worldwide basis. It has become increasingly difficult to design low cost electric motors that are economically viable for low cost consumer goods.

### SUMMARY

In view of the deficiencies of conventional electric motors, what is needed are innovations within the field of electric motor design that will reduce the overall cost and thereby allow electric motors to be used economically in low cost consumer goods. The improved stator of the present invention includes a structure that lowers both the quantity of copper and/or aluminum wire in the field coils and decreases the labor required to fabricate the motor.

Conventional fractional horsepower motors commonly use slot paper and other insulating components that increase the mean turn length of the copper coil as it is wound. Embodiments of the current invention use a close fitting molded insulator that conforms to the shape of the steel stator lamination stack. The advantage of this arrangement is that the distance the copper wire needs to travel around the pole of the stator is shortened when compared to stators that use slot paper and other conventional components.

Conventional fractional horsepower motors also require the utilization of elaborate mechanisms to wind the field coils onto the stator lamination stack. This is necessary since the opening utilized in the winding process of a conventional stator is normally confined to the rotor cavity at the center of the stator. The limited space available for the winding process requires the use of small fragile components and complicated mechanical systems. The limited space and the fragile equipment increase both the initial cost of the machinery and the possibility of production quality issues.

In some cases conventional motors have coils that are wound on separate machines (winders). The coils are subsequently removed (shed) from these machines and placed or inserted onto the stator (insertion machines). The insertion of the coil onto the stator is commonly done by a semi-manual process or a fully manual process, which not only increases the labor needed but also subjects the coil to the possibility of damage because of human error.

Embodiments of the current invention use an innovative multi-piece stator design that liberates the winding process from being confined to the small space of the rotor cavity. Since the stator of embodiments of the current invention is wound from an outside location relative to the rotor cavity, this permits a more robust and less complicated mechanical systems to be used when winding the field coils on the stator.

In short, the structure of the stator of embodiments of the current invention decreases the material quantity, simplifies manufacturing machinery, decreases labor requirements, increases quality, and lowers the cost of an electrical motor. These factors result in the possible continued use and possible new applications for low cost electric motors.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a perspective view of an embodiment of a pole cluster and a flux ring;

FIG. 2 is a perspective view assembly of the pole cluster and flux ring of FIG. 1;

FIGS. 3A, 3B, 3C, and 3D are enlarged perspective views of various features of embodiments of the current invention;

FIG. 4 is an enlarged perspective view of another feature embodiment of the current invention;

FIG. 5 is a front and top view of an embodiment of a first insulation member;

FIG. 6 is a front and bottom view of an embodiment of a second insulation member;

FIG. 7 is a front and top view of an assembly of an insulated pole cluster;

FIG. 8 is a front and top view of a partially wound insulated pole cluster of FIG. 7;

FIG. 9 is a front and top view of a completely wound insulated pole cluster of

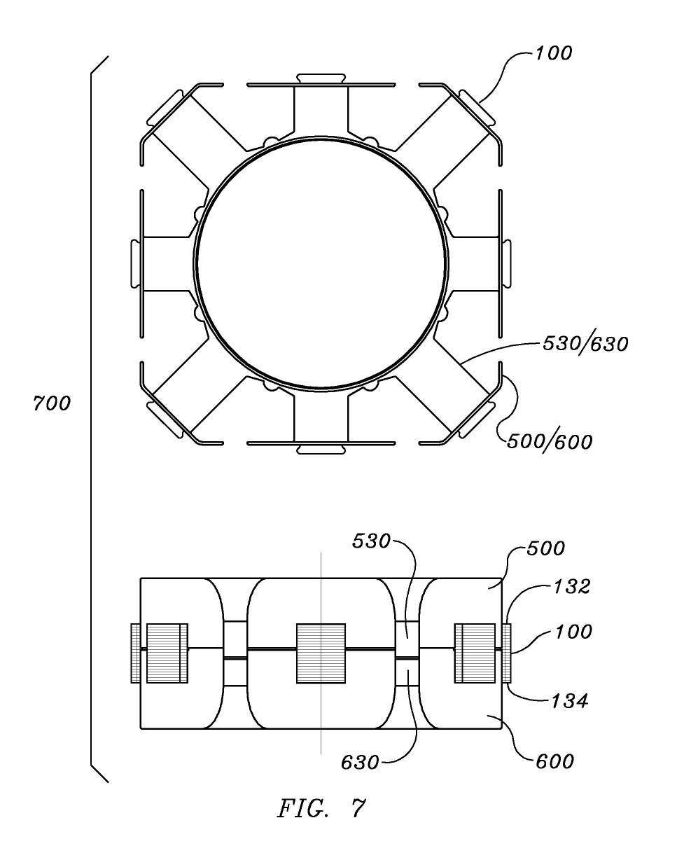

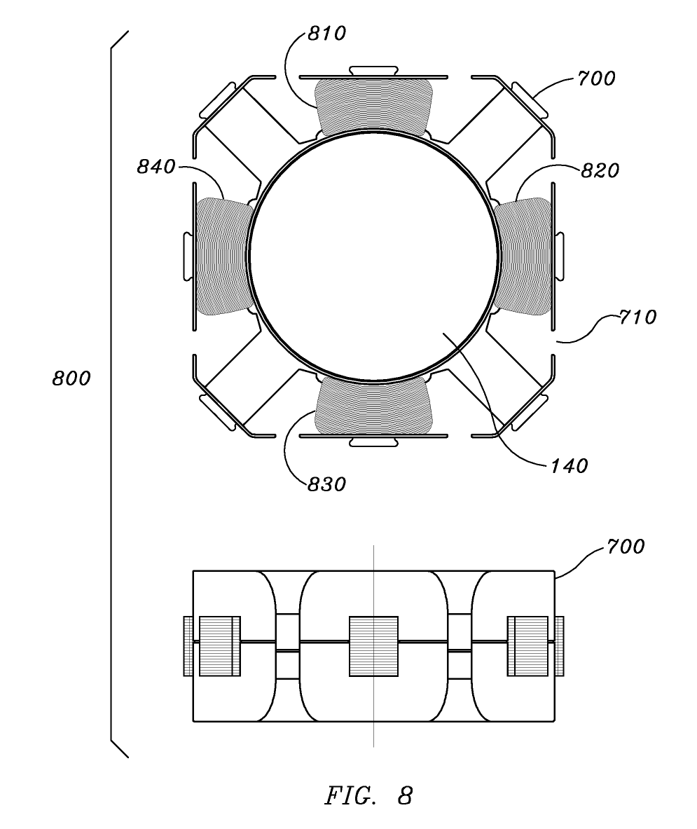

FIG. 7;

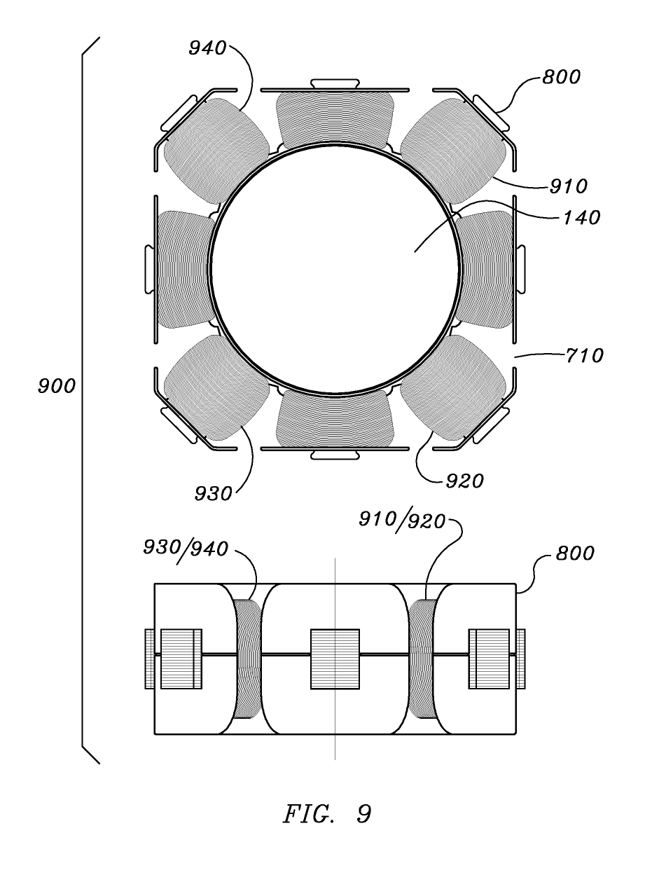

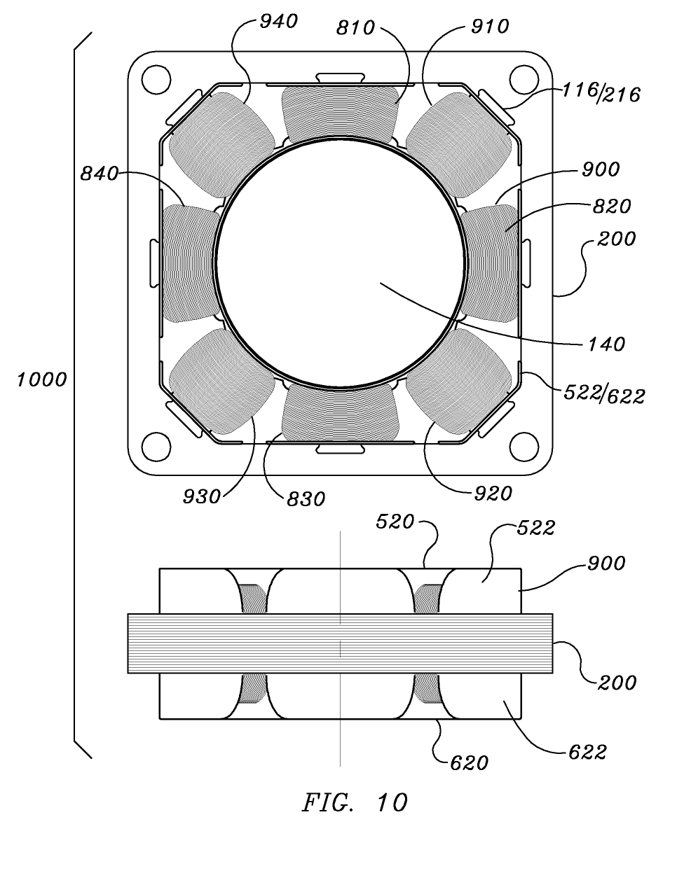

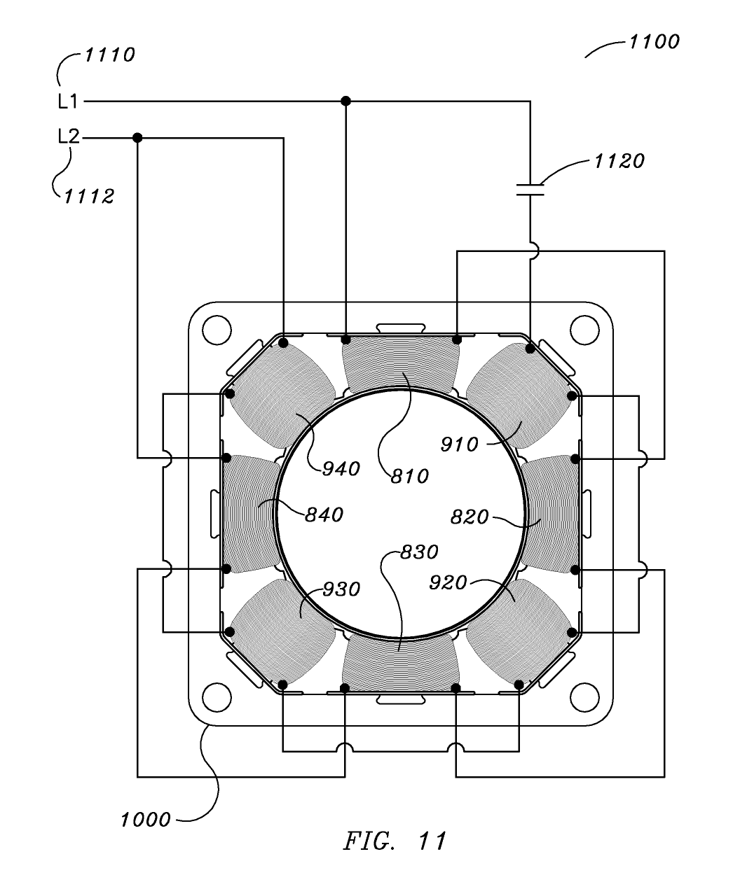

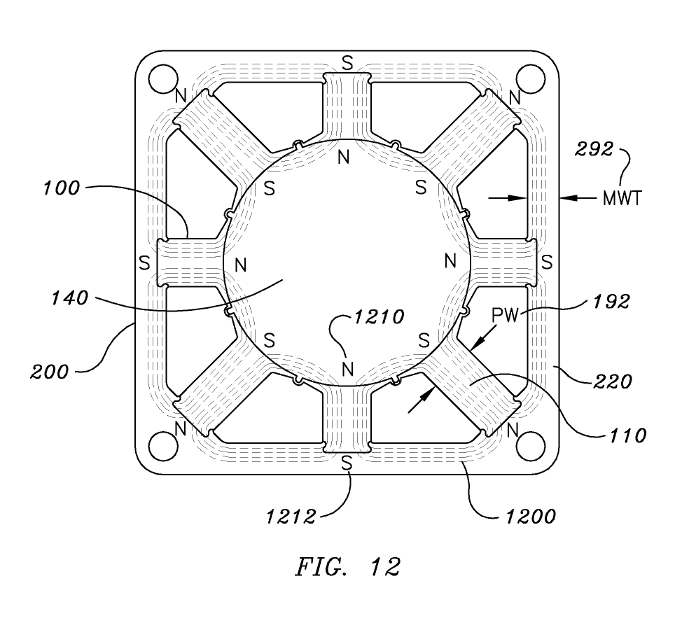

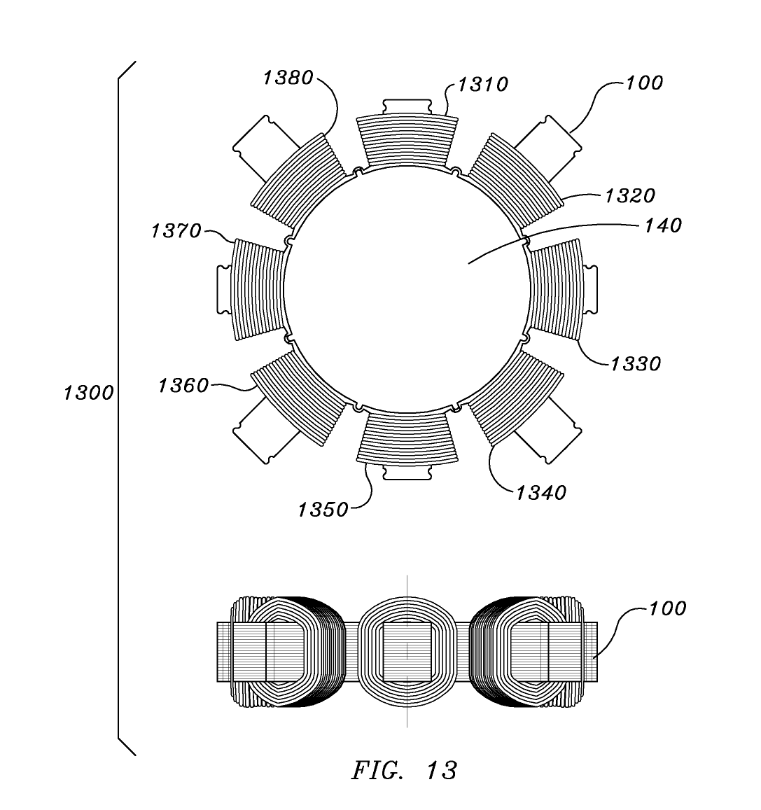

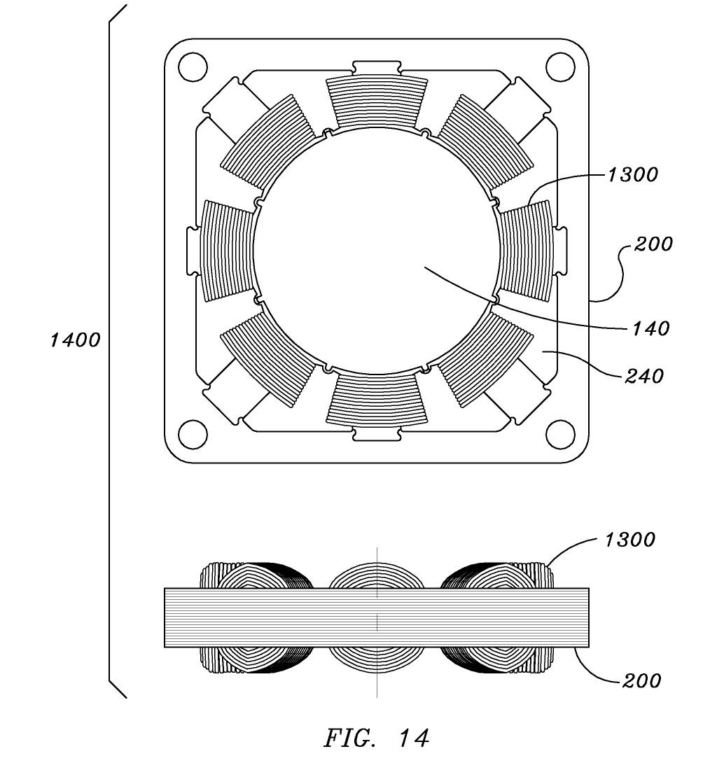

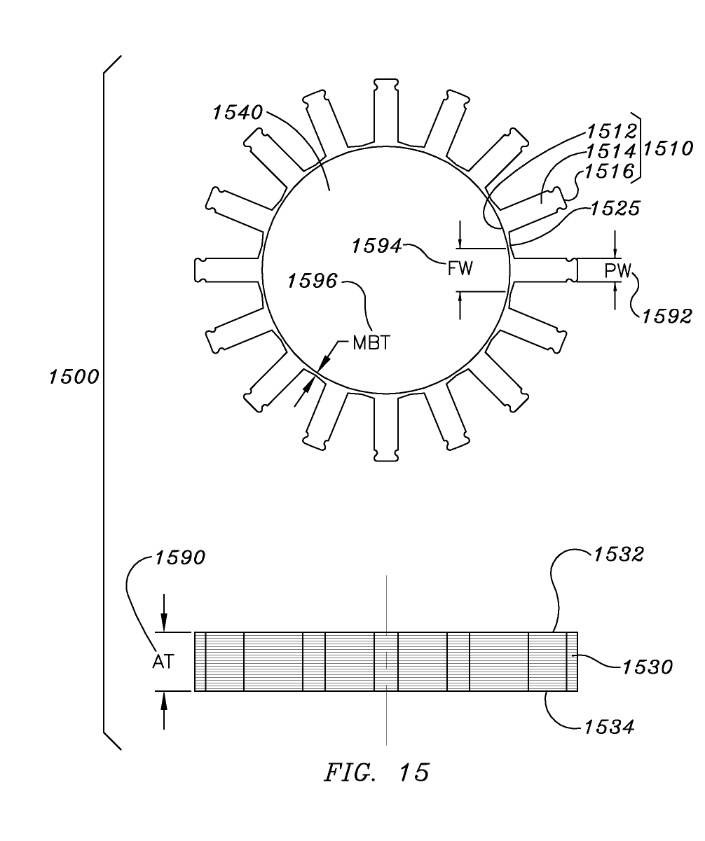

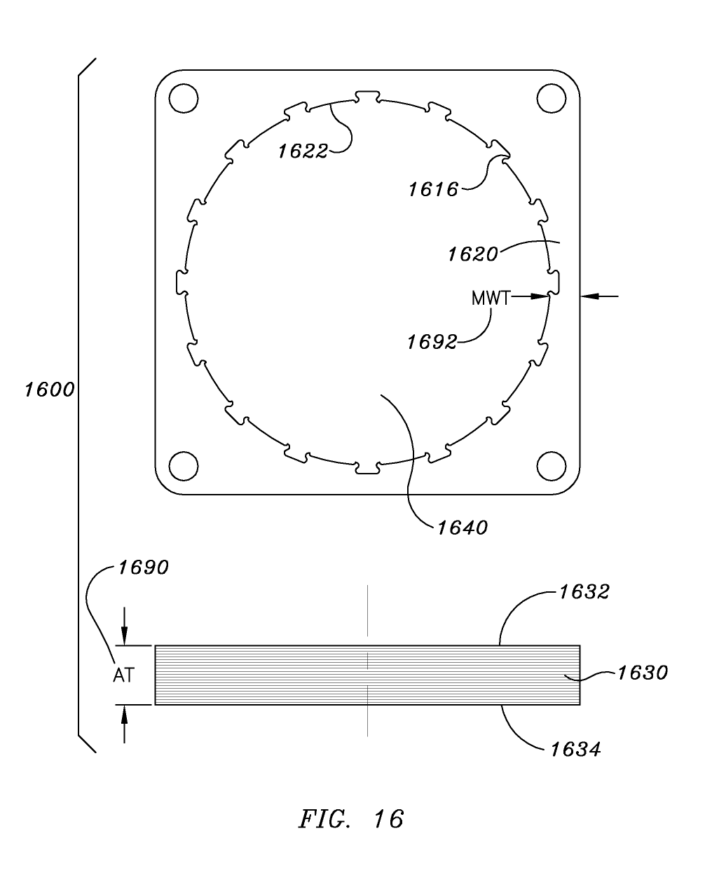

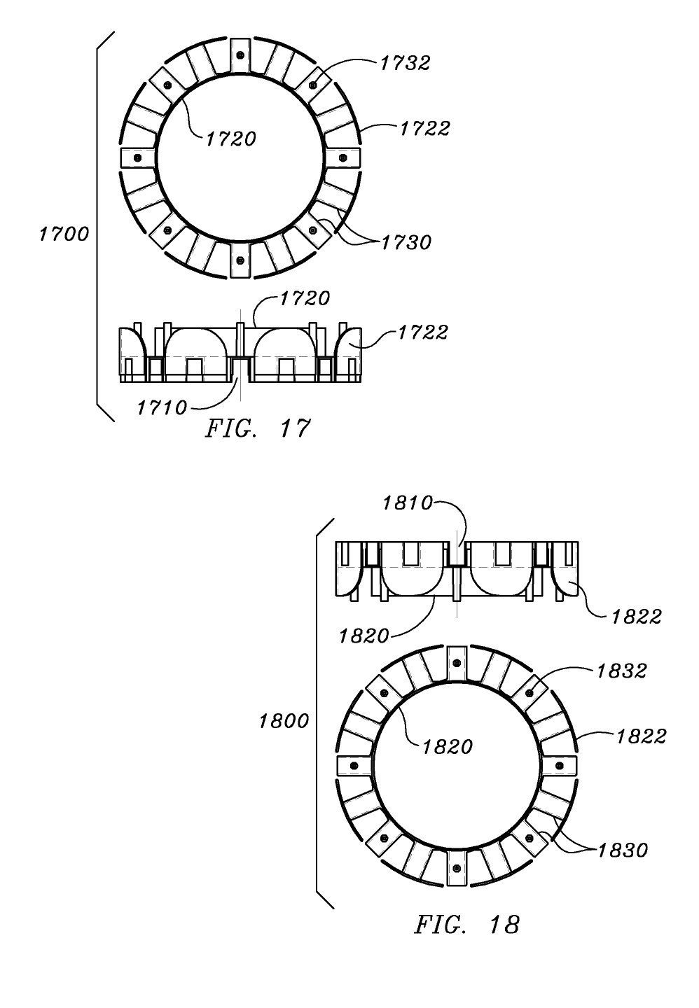

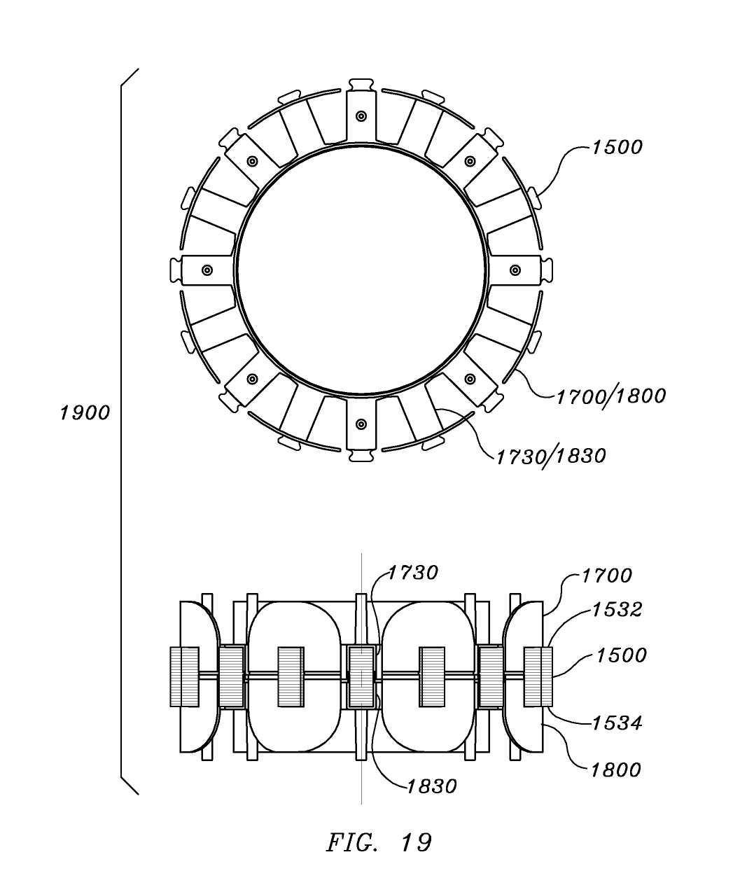

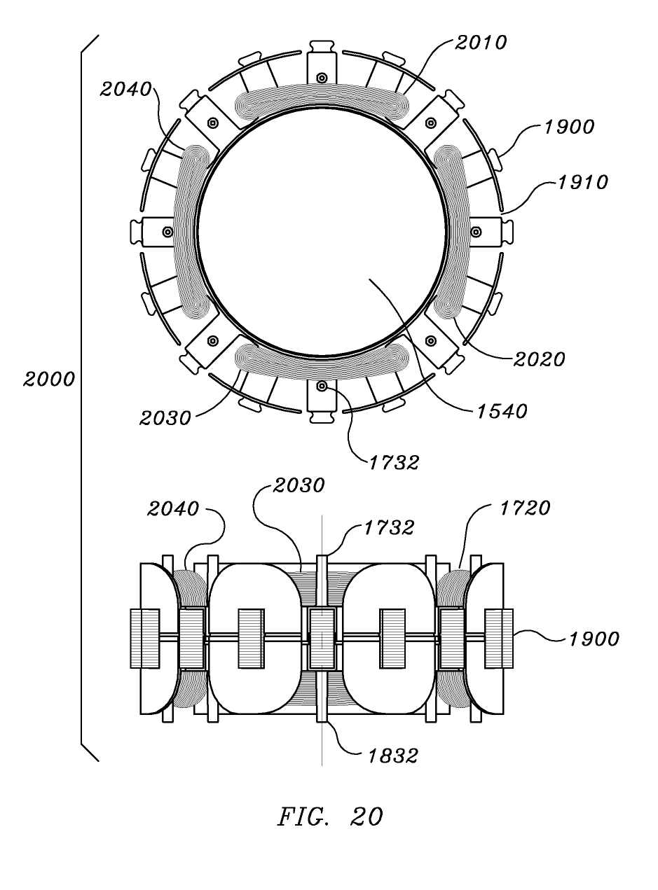

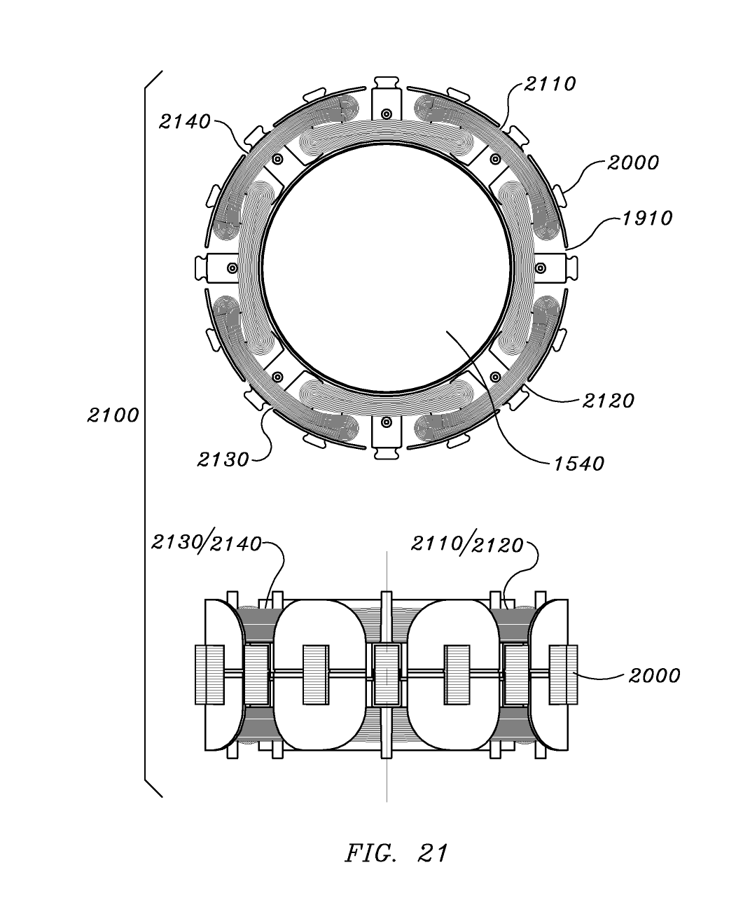

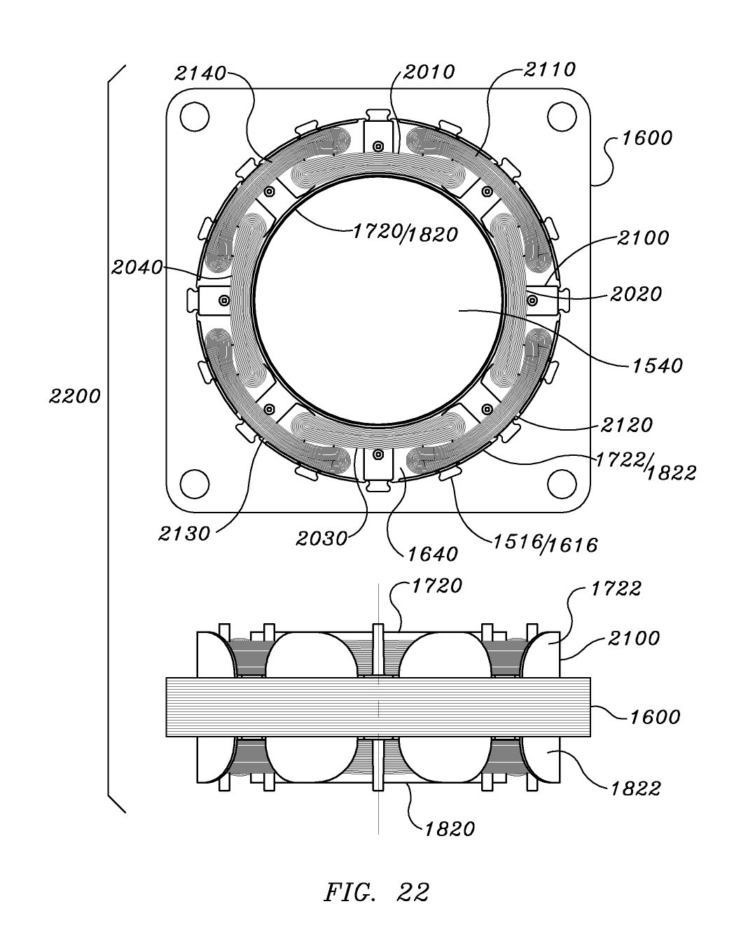

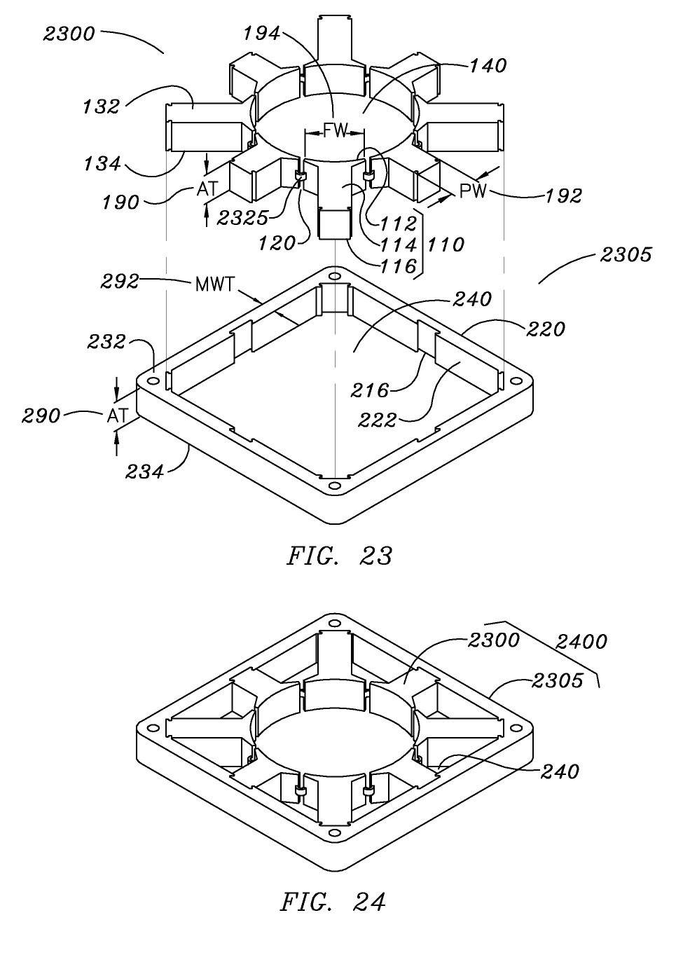

FIG. 10 is a front and top view of a final stator assembly of the completely wound insulated pole cluster of FIG. 9 and the flux ring of FIG. 1;

FIG. 11 is an embodiment of a wiring diagram of the final stator assembly of FIG. 10;

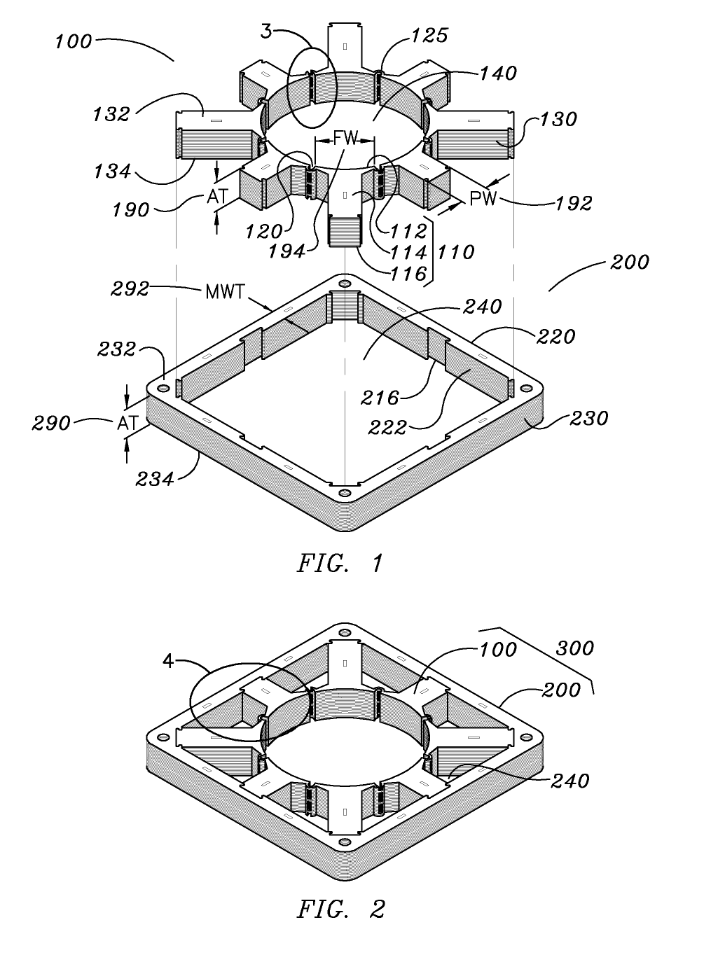

FIG. 12 is a top view of the assembly of FIG. 2 illustrating magnetic flux paths;

FIG. 13 is a front and top view of an alternative embodiment of a completely wound pole cluster of FIG. 1;

FIG. 14 is a front and top view of a final stator assembly of the completely wound pole cluster of FIG. 13 and the flux ring of FIG. 1;

FIG. 15 is a front and top view of an alternative embodiment of a pole cluster of the current invention;

FIG. 16 is a front and top view of an alternative embodiment of a flux ring;

FIG. 17 is a front and top view of an alternative embodiment of a first insulation member;

FIG. 18 is a front and bottom view of an alternative embodiment of a second insulation member;

FIG. 19 is a front and top view of an alternative assembly of an insulated pole cluster;

FIG. 20 is a front and top view of a partially wound insulated pole cluster of FIG. 19;

FIG. 21 is a front and top view of a completely wound insulated pole cluster of FIG. 19;

FIG. 22 is a front and top view of a final stator assembly of the completely wound pole cluster of FIG. 21 and the flux ring of FIG. 16;

FIG. 23 is a perspective view of another embodiment of a pole cluster and a flux ring of the current invention; and

FIG. 24 is a perspective view assembly of the pole cluster and flux ring of FIG. 23.

### DETAILED DESCRIPTION OF ILLUSTRATIVE EMBODIMENTS

FIG. 1 is a perspective view of pole cluster 100 and flux ring 200, according to an embodiment. Pole cluster 100 may be fabricated of magnetic materials, such as multiple cluster laminations 130. As shown pole cluster 100 includes multiple flux poles 110 located circumferentially around rotor cavity 140. Each of multiple flux poles 110 includes pole body 114 extending radially out from rotor cavity 140 toward a distal end, pole interface structure 116 located proximate the distal end, and pole foot 112 located proximate rotor cavity 140. Pole body 114 is defined by pole width (PW) 192, while pole foot 112 is defined by foot width (FW) 194. As shown, foot width 194 is greater than pole width 192.

Multiple flux gaps 120 are located between each pole foot 112 of multiple flux poles 110 located circumferentially about rotor cavity 140. Multiple flux gap bridges 125 connect and locate each of multiple flux poles 110 relative to each other. Rotor cavity 140 is defined by multiple pole feet 112, multiple flux gaps 120 and multiple flux gap bridges 125.

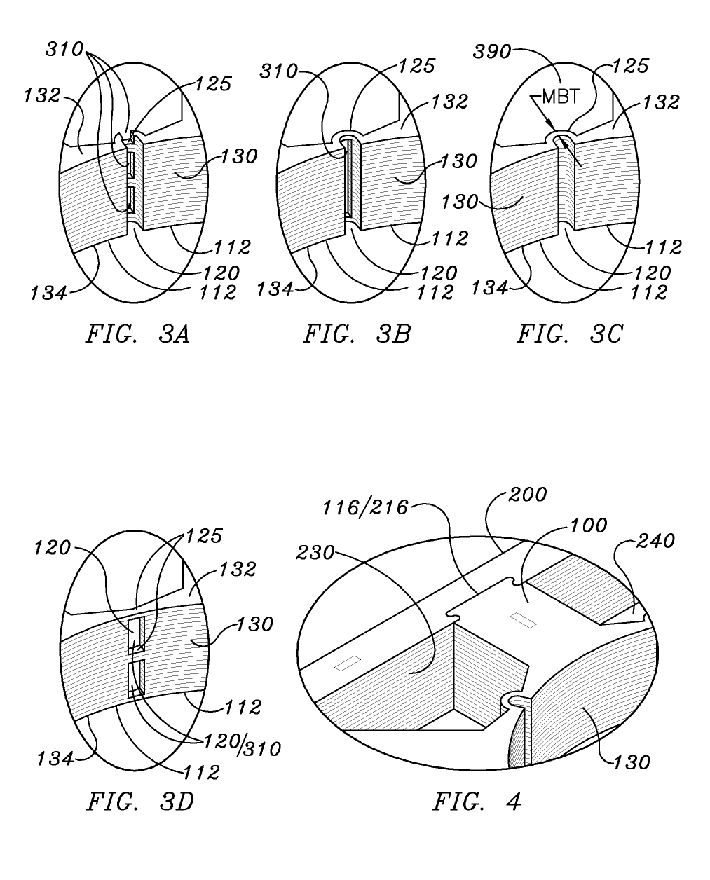

First cluster side 132 and second cluster side 134 are spaced apart by a predetermined cluster axial thickness (AT) 190. Multiple cluster laminations 130 may be assembled together by rivets, screws, welding, stamped interlocking features, or other well-known assembly methods. Also shown is detail view 3 which corresponds to FIGS. 3A-3D, described in greater detail below.

Flux ring 200 may be fabricated of magnetic materials, such as multiple ring laminations 230. As shown with continued reference to FIG. 1, flux ring 200 includes ring wall 220 having inside wall 222 which defines pole cluster cavity 240. Multiple ring interface structures 216 are located along a surface of inside wall 222. First ring side 232 and second ring side 234 are spaced apart by a predetermined ring axial thickness (AT) 290. Minimum wall thickness (MWT) 292 is the minimum thickness of ring wall 220 at a portion not including ring interface structure 216. Multiple ring laminations 230 may be assembled together by rivets, screws, welding, stamped interlocking features, or other well-known assembly methods.

FIG. 2 is a perspective view of stator core assembly 300, according to an embodiment. As shown, pole cluster 100 is located in pole cluster cavity 240 of flux ring 200. Also shown is detail view 4 which corresponds to FIG. 4, described in greater detail below.

FIGS. 3A, 3B, 3C, and 3D are enlarged perspective views of view 3 shown in FIG. 1. FIG. 3A shows flux gap bridge 125 as an arcuate extension of a cluster laminations 130 connecting pole foot 112 of one flux pole 110 to a pole foot 112 of an adjacent flux pole 110 on the same layer of cluster laminations 130. Voids 310 remove the material connection of flux gap bridges 125 between adjacent pole feet 112 on specific layers of cluster laminations 130. Voids 310 improve the flow path of magnetic flux 1200 (see FIG. 12). As shown in the embodiment of FIG. 3A, flux gap bridges 125 are located near first cluster side 132, second cluster side 134, and the center of cluster axial thickness 190.

In the embodiment of FIG. 3B, flux gap bridges 125 are located near first cluster side 132 and second cluster side 134 while void 310 extends between flux gap bridges 125.

In the embodiment of FIG. 3C, flux gap bridges 125 correspond to all layers of cluster laminations 130. The use of flux gap bridges 125 as shown increases the structural strength of pole cluster 100; however, this structure may be detrimental to the flow path of magnetic flux 1200 (see FIG. 12). As such, maximum bridge thickness (MBT) 390 should be maintained at a minimal dimension in order to impede the direct flow of magnetic flux 1200 between adjacent pole feet 112. In one embodiment, the maximum bridge thickness 390 is equal to or less than a single lamination thickness of cluster laminations 130.

FIG. 3D shows flux gap bridges 125 as a continuation of the profile of pole foot 112 on a layer of cluster laminations 130 connecting an adjacent pole foot 112 on the same layer of cluster laminations 130. Voids 310 remove the material connection of flux gap bridges 125 between adjacent pole feet 112 on specific layers of cluster laminations 130. Flux gap bridges 125, in this embodiment, are located near first cluster side 132, second cluster side 134, and the center of cluster axial thickness 190. As shown, flux gaps 120 coincide with voids 310.

As shown in FIGS. 3A, 3B, 3C and 3D, flux gap 120, void 310, and flux gap bridge 125 may be used in various configurations to acquire the desired magnetic and structural characteristics for a specific motor application. In general, one or more voids 310 and flux gaps 120 embody a flux impedance feature that prevents the direct flow of magnetic flux 1200 (see FIG. 12) between adjacent flux poles 110. At the same time, one or more flux gap bridges 125 embody a bridge feature between adjacent pole feet 112 which preserves the structural integrity of pole cluster 100 while minimizing the magnetic material connecting adjacent flux poles 110. Although the bridge feature embodied in flux gap bridge 125 is shown as an arcuate shape and/or a profile extension of cluster laminations 130, the invention is not so limited. It is contemplated that other shapes and forms can be used without departing from the spirit of the invention.

FIG. 4 is an enlarged perspective of view 4 shown in FIG. 2. As shown, pole interface structures 116 and ring interface structures 216 are close fitting “dove-tail” shaped features. As such, pole cluster 100 and flux ring 200 are assembled by moving pole cluster 100 into pole cluster cavity 240 along a path parallel to cluster axial thickness 190 of pole cluster 100 and ring axial thickness 290 of flux ring 200.

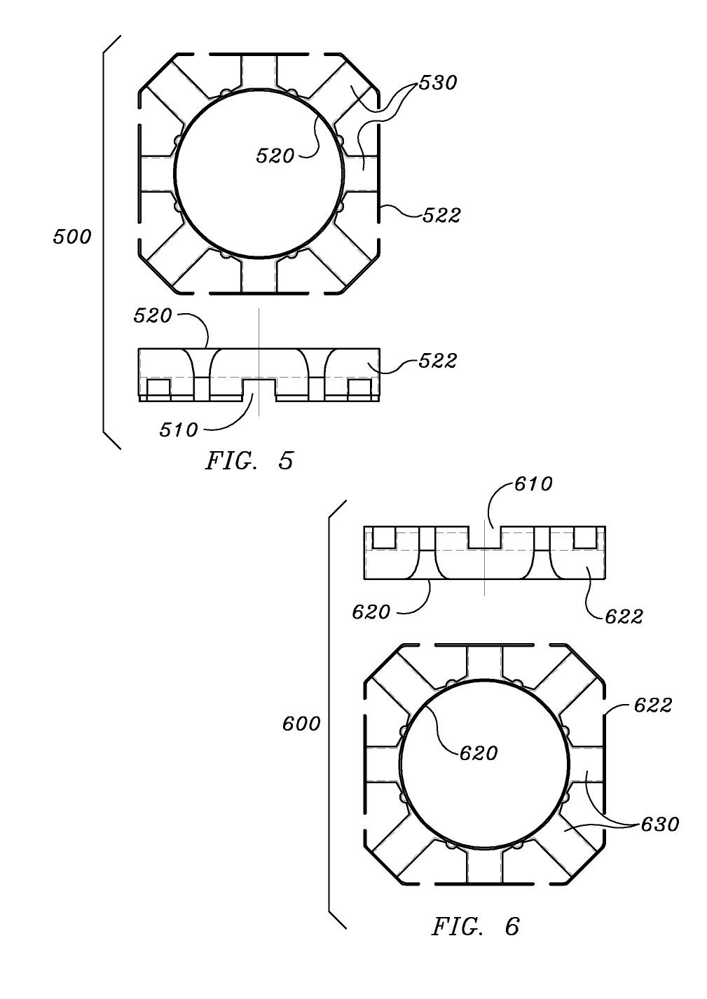

FIG. 5 is a top and front view of an embodiment of a first insulation member 500. First insulation member 500 may include internal wall 520, circumferential walls 522, and axial wall 530. Axial wall 530 defines pole cavities 510, which conform substantially to the shape of flux poles 110 of FIG. 1. First insulation member 500 may be fabricated of a single unitary piece or multiple pieces assembled together. First insulation member 500 may be fabricated of an electrically isolative material, such as injection molded polymer, vacuum formed polymer, formed paper, and the like.

FIG. 6 is a front and bottom view of an embodiment of a second insulation member 600. Second insulation member 600 may include internal wall 620, circumferential walls 622, and axial wall 630. Axial wall 630 defines pole cavities 610 which conform substantially to the shape of flux poles 110 of FIG. 1. Second insulation member 600 may be fabricated of a single unitary piece or multiple pieces assembled together. Second insulation member 600 may be fabricated of an electrically isolative material, such as injection molded polymer, vacuum formed polymer, formed paper, and the like.

FIG. 7 is a top and front view of insulated pole cluster 700, according to an embodiment. As shown, first insulation member 500 and second insulation member 600 are located on first cluster side 132 and second cluster side 134, respectively, of pole cluster 100. Axial walls 530 and 630 extend toward each other and may overlap to cover flux poles 110. First and second insulation members 500 and 600 may be held in place by a close form fit on pole cluster 100, adhesives, heat shrinkage, and/or the like.

FIG. 8 is an illustration of a top and front view of partially wound insulated pole cluster 800, according to an embodiment. Unlike conventional stator designs which are commonly wound from the center of the stator, (i.e. from rotor cavity 140), winding slots 710 are located on the outside circumference of insulated pole cluster 700. The location of winding slots 710 allows more robust and less complicated mechanical systems to be used when winding primary coils 810, 820, 830, and 840 on insulated pole cluster 700. The location of winding slots 710 may require less manual labor during and after the coil winding process.

FIG. 9 is an illustration of a top and front view of completely wound insulated pole cluster 900, according to an embodiment. Secondary coils 910, 920, 930, and 940 are wound on partially wound insulated pole cluster 800. All of the advantages of the location of winding slots 710 described in association with FIG. 8 are applicable to FIG. 9 as well.

FIG. 10 is a front and top view of final stator assembly 1000, according to an embodiment. As shown, completely wound insulated pole cluster 900 is inserted into pole cluster cavity 240 of flux ring 200. As such, pole interface structures 116 and ring interface structures 216 are utilized to maintain the assembly 1000 via a press fit. It is contemplated that adhesives and other additional components may be added to the final stator assembly 1000 to maintain the assembled relationship between completely wound insulated pole cluster 900 and flux ring 200. As shown, internal walls 520, 620 and circumferential walls 522, 622 control primary coils 810, 820, 830, 840 and secondary coils 910, 920, 930, 940, preventing any portion of the coil wires from entering rotor cavity 140 or contacting flux ring 200.

FIG. 11 is an embodiment of a wiring diagram 1100 of final stator assembly 1000. In the current embodiment, line 1 (L1) 1110 is one side and line 2 (L2) 1112 is the other side of an alternating current power supply to final stator assembly 1000. As shown, primary coils 810, 820, 830, and 840 are connected in series relative to one another, while secondary coils 910, 920, 930, and 940 are connected in series relative to one another. Wiring diagram 1100 includes capacitor 1120 in series with secondary coils 910, 920, 930, and 940. As shown, final stator assembly 1000 is electrically connected as a four pole capacitor start electric motor.

FIG. 12 is a top view of an assembly of stator core assembly 300. When fully assembled as per stator assembly 1000 of FIG. 10, and primary coils 810, 820, 830, 840 and secondary coils 910, 920, 930, 940 are electrically energized, magnetic flux 1200 is generated in stator core assembly 300. When alternating electrical current is utilized to generate magnetic flux 1200, north polarization 1210 and south polarization 1212 create the proper conditions for a rotating magnetic field commonly used in alternating current (AC) electric motors, and more specifically in AC induction motors. In one embodiment, minimum wall thickness 292 is equal to or greater than 25% of pole width 192. In this manner, there is minimal impedance to the flow of magnetic flux 1200 through flux pole 110 and ring wall 220.

FIG. 13 is a top and front view of an alternative embodiment of a completely wound pole cluster. As shown, primary coils 1310, 1330, 1350, 1370 of completely wound pole cluster 1300 are constructed of insulated wire. Similarly, secondary coils 1320, 1340, 1360, and 1380 of completely wound pole cluster 1300 are also constructed of insulated wire. Unlike completely wound insulated pole cluster 900, completely wound pole cluster 1300 is constructed absent first insulation member 500 and second insulation member 600. The use of insulated wire for primary coils 1310, 1330, 1350, 1370 and secondary coils 1320, 1340, 1360, and 1380 is to impede electrical contact with pole cluster 100.

FIG. 14 is a top and front view of final stator assembly 1400 with the alternative embodiment of completely wound pole cluster 1300. As shown, completely wound pole cluster 1300 is inserted into pole cluster cavity 240 of flux ring 200. As such, pole interface structures 116 and ring interface structures 216 are utilized to maintain assembly 1400 via a press fit. In one embodiment, a wire size and/or an insulation structure of primary coils 1310, 1330, 1350, 1370 and secondary coils 1320, 1340, 1360, 1380 is sufficient to prevent any portion of the wires from entering rotor cavity 140 or contacting flux ring 200. It is contemplated that adhesives, varnish, bondable wire, and the like may be used as well to prevent any portion of the coil wires from entering rotor cavity 140 or contacting flux ring 200.

It is also contemplated that coatings, such as epoxies, paints, and the like, may be applied to pole cluster 100 and flux ring 200 to provide the required isolative properties to electrically isolate the primary and the secondary coils from pole cluster 100 and flux ring 200.

FIG. 15 is a top and front view of an embodiment of pole cluster 1500, according to an additional embodiment. Pole cluster 1500 may be fabricated of magnetic materials, such as multiple cluster laminations 1530. As shown, pole cluster 1500 includes multiple flux poles 1510 located circumferentially around rotor cavity 1540. Each of multiple flux poles 1510 includes pole body 1514 extending radially outward from rotor cavity 1540 toward a distal end, pole interface structure 1516 located proximate the distal end, and pole foot 1512 is located proximate rotor cavity 1540. Pole body 1514 is defined by pole width (PW) 1592 while pole foot 1512 is defined by foot width (FW) 1594. As shown, foot width 1594 is greater than pole width 1592.

As shown, flux gap bridge 1525 is a continuation of the profile of a pole foot 1512 on a layer of cluster laminations 1530 connecting an adjacent pole foot 1512 on the same layer of cluster laminations 1530, similar to flux gap bridge 125 of FIG. 3D. Multiple flux gap bridges 1525 connect and locate each of multiple flux poles 1510 relative to each other. Rotor cavity 1540 is defined by multiple pole feet 1512 and multiple flux gap bridges 1525. Maximum bridge thickness (MBT) 1596 should be maintained at a minimal dimension in order to impede the direct flow of a magnetic flux between adjacent pole feet 1512 while simultaneously preserving the structural integrity of pole cluster 1500. It is contemplated that flux gap bridge 1525 may also have other characteristics, such as those described with respect to FIGS. 3A, 3B, 3C, and 3D, without departing from the spirit of the invention, such as for example, arcuate shapes, voids, and the like.

First cluster side 1532 and second cluster side 1534 are spaced apart by a predetermined cluster axial thickness (AT) 1590. Multiple cluster laminations 1530 may be assembled together by rivets, screws, welding, stamped interlocking features, or other well-known assembly methods.

FIG. 16 is a top and front view of an embodiment of flux ring 1600. Flux ring 1600 may be fabricated of magnetic materials, such as multiple ring laminations 1630. As shown, flux ring 1600 includes ring wall 1620 having inside wall 1622 which defines pole cluster cavity 1640. Multiple ring interface structures 1616 are located along an internal circumference of inside wall 1622. First ring side 1632 and second ring side 1634 are spaced apart by a predetermined ring axial thickness (AT) 1690. Minimum wall thickness (MWT) 1692 is the minimum thickness of ring wall 1620, not including ring interface structure 1616. Multiple ring laminations 1630 may be assembled together by rivets, screws, welding, interlocking features, or other well-known assembly methods.

FIG. 17 is a top and front view of an embodiment of a first insulation member 1700. First insulation member 1700 may include internal wall 1720, circumferential walls 1722, axial walls 1730, and winding posts 1732. Axial walls 1730 define pole cavity 1710 which conforms substantially to the shape of flux poles 1510 of FIG. 15. First insulation member 1700 may be fabricated of a single unitary piece or multiple pieces assembled together. First insulation member 1700 is fabricated of an electrically isolative material, such as injection molded polymer, vacuum formed polymer, formed paper, and the like.

FIG. 18 is a front and bottom view of an embodiment of a second insulation member 1800. Second insulation member 1800 may include internal wall 1820, circumferential walls 1822, axial walls 1830, and winding posts 1832. Axial walls 1830 defines pole cavity 1810 which conforms substantially to the shape of flux poles 1510 of FIG. 15. Second insulation member 1800 may be fabricated of a single unitary piece or multiple pieces assembled together. Second insulation member 1800 is fabricated of an electrically isolative material such as injection molded polymer, vacuum formed polymer, formed paper, and the like.

FIG. 19 is a top and front view of insulated pole cluster 1900. As shown, first insulation member 1700 and second insulation member 1800 are located on first cluster side 1532 and second cluster side 1534, respectively, of pole cluster 1500. Axial walls 1730 and 1830 extend toward each other and may overlap to cover flux poles 1510. First and second insulation members 1700 and 1800 may be held in place by a close form fit on pole cluster 1500, adhesives, heat shrinkage, and/or the like.

FIG. 20 is a top and side illustration of partially wound insulated pole cluster 2000. Unlike conventional stator designs, which are commonly wound from the center of the stator (i.e. from rotor cavity 1540), winding slots 1910 are located on the outside circumference of insulated pole cluster 1900. The location of winding slots 1910 allows more robust and less complicated mechanical systems to be used when winding primary coils 2010, 2020, 2030, and 2040 on insulated pole cluster 1900. The location of winding slots 1910 may requires less manual labor during and after the coil winding process.

FIG. 21 is a top and side illustration of completely wound insulated pole cluster 2100. Secondary coils 2110, 2120, 2130, and 2140 are wound on partially wound insulated pole cluster 2000. All of the advantages of the location winding slots 1910 described in association with FIG. 20 are applicable to FIG. 21 as well.

FIG. 22 is a top and front view of a final stator assembly 2200. As shown, completely wound insulated pole cluster 2100 is inserted into pole cluster cavity 1640 of flux ring 1600. As such, pole interface structures 1516 and ring interface structures 1616 are utilized to maintain the assembly 2200 via a press fit. It is contemplated that adhesives and other additional components may be added to the final stator assembly 2200 to maintain the assembled relationship between completely wound insulated pole cluster 2100 and flux ring 1600. As shown, internal walls 1720, 1820 and circumferential walls 1722, 1822 control primary coils 2010, 2020, 2030, 2040 and secondary coils 2110, 2120, 2130, 2140, preventing any portion of the coil wires from entering rotor cavity 1540 or contacting flux ring 1600.

A wiring diagram of final stator assembly 2200 may be similar to wiring diagram 1100, i.e. as a four pole capacitor start electric motor. However, insulated pole cluster 1900 may be wound and wired as an eight or two pole capacitor start electric motor. In short, the invention is not limited by the number of electrical wound poles.

FIG. 23 is a perspective view of pole cluster 2300 and flux ring 2305. Pole cluster 2300 is a unitary structure utilizing magnetic materials. The unitary structure of pole cluster 2300 may be a fabricated of cast metal, machined metal, sintered powdered metal, and/or the like. It is also contemplated that a polymer which includes metallic or magnetically conductive fillers may be utilized with an injection molding process to form the structure of pole cluster 2300. As shown, pole cluster 2300 includes multiple flux poles 110 located circumferentially around rotor cavity 140. Multiple flux gap bridges 2325 are used to maintain the circumferential relationship of multiple flux poles 110 about rotor cavity 140.

Flux ring 2305 is a unitary structure utilizing magnetic materials and may be fabricated of materials and processes similar to pole cluster 2300. In all other respects, pole cluster 2300 and flux ring 2305 are similar to pole cluster 100 and flux ring 200, respectively, described with respect to FIG. 1.

FIG. 24 is a perspective view of stator core assembly 2400. As shown, pole cluster 2300 is located in pole cluster cavity 240 of flux ring 2305. In all other respects, stator core assembly 2400 is similar to stator core assembly 300 as described with respect to FIG. 2.

Final stator assemblies 1000, 1400 and 2200 use an innovative multi-piece stator design which liberates the winding process from confinement to the small space of rotor cavities 140 and 1540. Winding insulated pole cluster 700 and insulated pole cluster 1900 from an outside peripheral direction has many advantages when compared to conventional electric motor stators. In short, the innovative structure of embodiments of the present invention simplifies manufacturing machinery and processes, decreases labor requirements, and decreases the material quantity resulting in a lower cost for an electrical motor.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A stator for use in an electric motor comprising:
a pole cluster having a pole cluster axial thickness, a first cluster side, and a second cluster side substantially parallel to said first cluster side and offset from said first cluster side by a distance corresponding to said pole cluster axial thickness, said pole cluster comprising:
multiple layers of magnetic material;
a rotor cavity located at a center of said pole cluster;
multiple flux poles extending radially outward from said rotor cavity in a circumferential arrangement, each of said flux poles comprising:
a pole foot located proximate said rotor cavity;
a pole body extending radially outward from said pole foot to a distal end; and
a pole interface structure located on said distal end of said pole body;
a flux impedance feature between said pole feet of each of said multiple flux poles;
multiple bridge features, each comprising magnetic material extending from one of said pole feet of one of said multiple layers of said pole cluster to an adjacent pole foot corresponding to the same one of said multiple layers of said pole cluster;
a flux ring having a flux ring axial thickness, a first ring side, and a second ring side substantially parallel to said first ring side and offset from said first ring side by a distance corresponding to said flux ring axial thickness, said flux ring comprising:
multiple layers of magnetic material;
a ring wall having a minimum wall thickness;
at least one ring interface structure on an inside wall corresponding to at least one pole interface structure;
a pole cluster cavity defined by said ring wall;
and
wherein said multiple bridge features maintain said circumferential arrangement of said multiple flux poles relative to each other prior to an insertion of said pole cluster into said pole cluster cavity of said flux ring.

2. The stator of claim 1, further comprising at least one field generation coil comprising electrically conductive wire wrapped around at least one of said multiple pole bodies.

3. The stator of claim 2, wherein said pole cluster and said at least one field generation coil are inserted into said pole cluster cavity of said flux ring.

4. The stator of claim 3, wherein said at least one ring interface structure and said corresponding at least one pole interface structure maintain a locational relationship between said pole cluster, said at least one field generation coil, and said flux ring subsequent to said insertion.

5. The stator of claim 1, further comprising an insulation member comprising:
at least one of a first insulation member located proximate said first cluster side and extending toward said second cluster side and a second insulation member located proximate said second cluster side and extending toward said first cluster side;
wherein a shape of said first and second insulation members corresponds substantially to a shape of said multiple flux poles.

6. The stator of claim 5, further comprising at least one field generation coil comprising electrically conductive wire wrapped around at least a portion of said insulation member and at least a portion of said pole cluster.

7. The stator of claim 6, wherein said pole cluster, said insulation member, and said at least one field generation coil are inserted into said pole cluster cavity of said flux ring.

8. The stator of claim 7, wherein said at least one ring interface structure and said corresponding at least one pole interface structure maintain a locational relationship between said pole cluster, said insulation member, said at least one field generation coil, and said flux ring subsequent to said insertion.

9. The stator of claim 5, wherein said insulation member further comprises at least one injection molded polymer component.

10. The stator of claim 9, further comprising at least one field generation coil comprising electrically conductive wire wrapped around at least a portion of said insulation member and at least a portion of said pole cluster;
wherein said insulation member further comprises at least one winding post configured to guide said electrical conductive wire in a manner to allow multiple field generation coils to be wrapped on said pole cluster.

11. The stator of claim 1, each of said multiple pole bodies having a pole width, wherein said minimal wall thickness of said ring wall of said flux ring is equal to or greater than 25% of said pole width.

12. The stator of claim 1, wherein said pole cluster axial thickness and said flux ring axial thickness are substantially equal.

13. A field coil assembly for use in an electric motor comprising:
a pole cluster comprising:
multiple layers of magnetic material;
a rotor cavity located at a center of said pole cluster
multiple flux poles extending radially outward from said rotor cavity in a circumferential arrangement, each of said flux poles comprising:
a pole foot located proximate said rotor cavity;
a pole body extending radially outward from said pole foot to a distal end;
a flux impedance feature between said pole feet of each of said multiple flux poles;
multiple bridge features maintaining said circumferential arrangement of said multiple flux poles, each bridge feature comprising magnetic material extending from one of said pole feet of one of said multiple layers of said pole cluster to an adjacent pole foot corresponding to the same one of said multiple layers of said pole cluster;
a flux ring comprising:
multiple layers of magnetic material;
a ring wall having a minimum wall thickness;
a pole cluster cavity defined by said ring wall;
an insulation member comprising a shape corresponding substantially to a shape of said pole cluster and located to effectively cover an outside surface of said multiple flux poles;
at least one field generation coil comprising electrically conductive wire wrapped around a portion of said insulation member and at least one of said multiple flux poles; and
wherein said pole cluster, said insulation member, and said at least one field generation coil are inserted into said pole cluster cavity of said flux ring.

14. The field coil assembly of claim 13, wherein:
at least one of said flux poles further comprises a pole interface structure located on said distal end of said pole body;
said flux ring further comprises at least one ring interface structure located on an inside wall of said flux ring corresponding to said at least one pole interface structure; and
said at least one pole interface structure and said at least one ring interface structure maintain a locational relationship between said pole cluster and said flux ring after said insertion.

15. The field coil assembly of claim 13, wherein said pole cluster further comprises:
a pole cluster axial thickness;
a first cluster side; and
a second cluster side substantially parallel to said first cluster side and offset from said first cluster side by a distance corresponding to said pole cluster axial thickness.

16. The field coil assembly of claim 15, wherein said insulation member further comprises at least one of:
a first insulation member located proximate said first cluster side and extending toward said second cluster side; and
a second insulation member located proximate said second cluster side and extending toward said first cluster side.

17. The field coil assembly of claim 15, wherein said flux ring further comprises:
a flux ring axial thickness;
a first ring side; and
a second ring side substantially parallel to said first ring side and offset from said first ring side by a distance corresponding to said flux ring axial thickness; and
wherein said pole cluster axial thickness and said flux ring axial thickness are substantially equal.

18. A method for assembling a field coil stator for an electric motor, the method comprising:
providing a pole cluster comprising:
multiple layers of magnetic material;
a rotor cavity located at a center of said pole cluster;
multiple flux poles extending radially outward from said rotor cavity in a circumferential arrangement, each of said flux poles comprising:
a pole foot located proximate said rotor cavity;
a pole body extending radially outward from said pole foot to a distal end;
wherein at least one of said flux poles further comprises a pole interface structure located on said distal end of said pole body;
a flux impedance feature between said pole feet of each of said multiple flux poles;
multiple bridge features maintaining said circumferential arrangement of said multiple flux poles, each bridge feature comprising magnetic material extending from one of said pole feet of one of said multiple layers of said pole cluster to an adjacent pole foot corresponding to the same one of said multiple layers of said pole cluster;
providing a flux ring comprising:
multiple layers of magnetic material;
a ring wall having a minimum wall thickness;
at least one ring interface structure on an inside wall corresponding to said at least one pole interface structure;
a pole cluster cavity defined by said ring wall;
providing an insulation member having a shape and form corresponding substantially to a shape of said multiple flux poles;
locating said insulation member around said multiple flux poles;
winding at least one field generation coil by wrapping electrically conductive wire around said insulation member and at least one of said flux poles from a radially outward location relative to said rotor cavity;
locating said at least one ring interface structure in said pole cluster cavity on an inside surface of said flux ring wall;
inserting said at least one field generation coil, said insulation member, and said multiple flux poles into said pole cluster cavity;
interlocking said at least one pole interface structure and said at least one ring interface structure; and
maintaining a locational relationship between said at least one generation coil, said insulation member, said multiple flux poles, and said flux ring outer wall through said interlocking.
